(19) United States
(12) Patent Application Publication
(10) Pub. No.: US 2014/0304092 A1
(43) Pub. Date: Oct. 9, 2014

(54) Method and apparatus for a revenue-sharing community-based website

(71) Applicant: Georgia U. Raysman, New York, NY (US)

(72) Inventor: Georgia U. Raysman, New York, NY (US)

(21) Appl. No.: 13/908,545

(22) Filed: Jun. 3, 2013

Related U.S. Application Data
(60) Provisional application No. 61/808,183, filed on Apr. 3, 2013.

(51) Int. Cl. G06Q 30/06

(52) U.S. Cl. CPC G06Q 30/0601
USPC 705/14.73; 705/26.1; 705/26.62

(57) ABSTRACT

Described herein is a website that may include an administrator portal, content portal and commerce portal, all associated with a locality. The administrator portal allows one or more administrators to maintain the website. The content portal allows one or more contributors associated with the locality to provide content to the website. The commerce portal allows one or more merchants associated with the locality to provide goods and services to users of the website.

### RELATED APPLICATIONS

This application claims the benefit of U.S. provisional patent application Ser. No. 61/808,183, filed Apr. 3, 2013.

### FIELD OF THE DISCLOSURE

The present disclosure relates generally to local-based websites and more particularly to revenue-sharing websites that are community based and allow for local seller marketplaces.

### BACKGROUND

The use of the Internet for local and “hyper-local” content is known. Local residents, whether seasonal or permanent, that share a common location often have common interests and establish websites that tracks such interests. A number of models of such local websites presently exist:
A. Centrally-owned but local-appearing sites, like those operated by Patch.com, which is owned by AOL. Although these are stated to be primarily local news sites, their content is packaged centrally with limited local input. They are staffed by paid professional journalists. Other than local advertisements, there is no attempt to integrate local commerce within the website.
B. Local homeowner association sites (such as www.broadlandshoa.org in Ashburn, Va.), which deal with issues of interest to the members of the (often gated) association and no one else. Robust e-commerce is usually not present on such sites.
C. Local news sites related to the local newspaper (such as www.ack.net, the website for the newspaper of Nantucket, Mass.). These are often behind paywalls so as not to cannibalize content present from the physical newspapers. Robust e-commerce is usually not present on such sites.
D. Local news sites operated independently by paid journalists, which can be profit-making (such as www.myveronanj.com) or non-profit (such as www.oaklandlocal.com). These sites generally do not have significant community participation or robust e-commerce.
E. Numerous e-commerce platforms that are completely divorced from any particular local community: Etsy and eBay are examples.

While useful, the foregoing websites do not include a combination of a robust e-commerce platform with a content portion where both content and revenue are produced locally and monies are retained within the community. Accordingly, there is a need for a local and hyper-local website that is revenue-sharing, provides a robust e-commerce platform for local artisans and retailers, and contains wide-ranging and varied original content from members of the local community in different formats.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a screen capture of a website for creating a local store in accordance with some embodiments.

FIG. 2 is a screen capture of a website for displaying local stores in accordance with some embodiments.

FIG. 3 is a screen capture of a website for displaying a payment screen in accordance with some embodiments.

FIG. 4 is a screen capture of a website for tracking orders in accordance with some embodiments.

FIG. 5 is a screen capture of a website for including local content integrated with local e-commerce capability in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The website described herein may include a control portal, content portal and commerce portal, all associated with a locality. The control portal allows one or more administrators to maintain the website. The content portal allows one or more contributors associated with the locality to provide content to the website. The commerce portal allows one or more merchants associated with the locality to provide goods and services to users of the website.

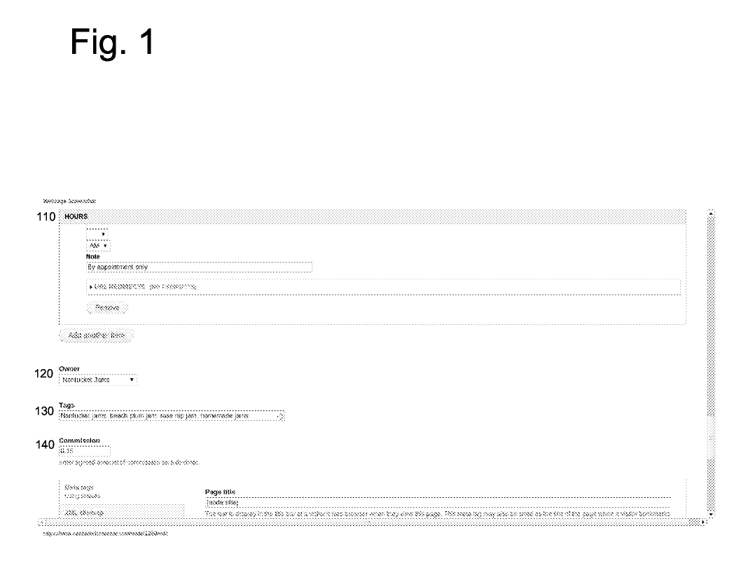

Turning to FIG. 1, shown is a screen capture of the back-end of a website where administrators may create a community store and assign a store owner. Data for the store may be entered so that it will appear in a properly formatted format on the front-end of the website. Such data may include store hours 110, store owner 120, tags 130 (for improved classification, indexing and search engine optimization) and a commission rate 140 that will be paid to the website administrator for sales through the website. Other store data (not shown) may also be entered including without limitation store address, store goods, store pricing and the like.

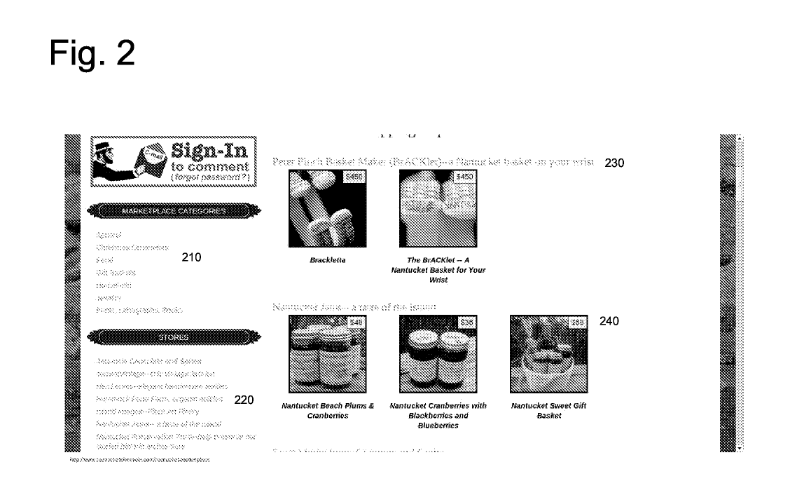

Turning to FIG. 2, shown is a screen capture of the front-end of a website showing community stores that may be accessed by customers. The stores may be classified by category 210 and by store name 220. The products sold by each of the store are displayed on the webpage 230, 240. The community stores may be organized by type of store or type of product such that they are easily navigable and searchable by website customers.

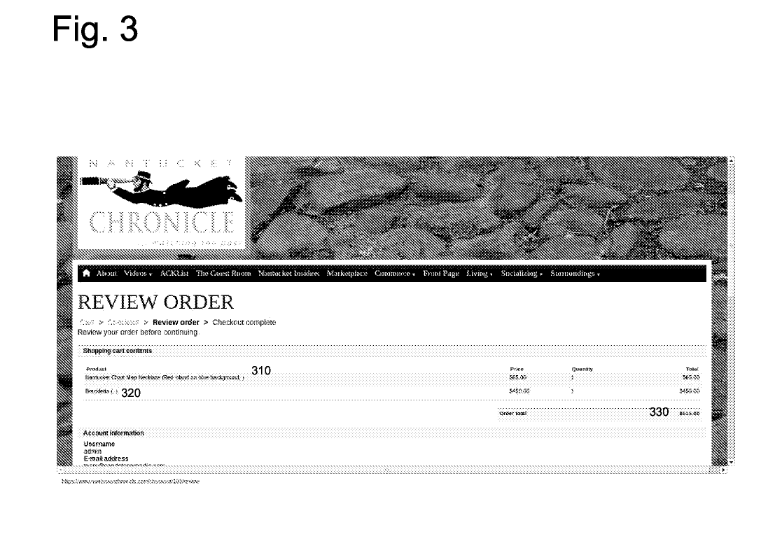

Turning to FIG. 3, shown is a screen capture of the front-end of a website showing a checkout function where a customer of the webpage may purchase goods ordered from the local stores. The website allows the customer to purchase items from multiple local stores 310, 320 and calculates an overall total 330. The website then collects the purchase price from the customer. After an order is complete the customer is emailed an invoice. The website splits the order into groups of products per store and emails the store owners their portion of the order. The store owners receive emails from the website that include their specific instructions on how to fulfill the orders from the website customers.

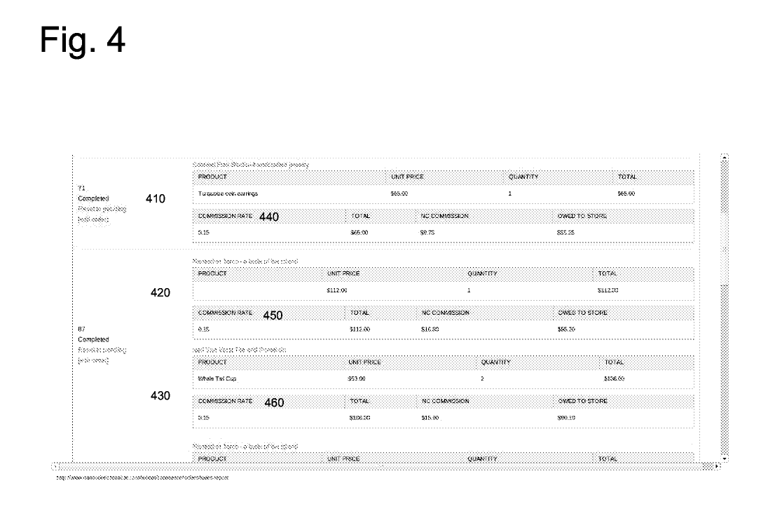

Turning to FIG. 4, shown is a screen capture of the back-end of a website showing a commission-tracking system for purchases made by customers. Each product that is purchased 410, 420, 430 from a pre-registered local store is associated with a pre-determined commission rate 440, 450, 460. Based on the commission rate, the website calculates the amount of the purchase price remitted by the website customer that will be retained by the website administrator as commission. The website administrator will then remit the remaining balance to the local store.

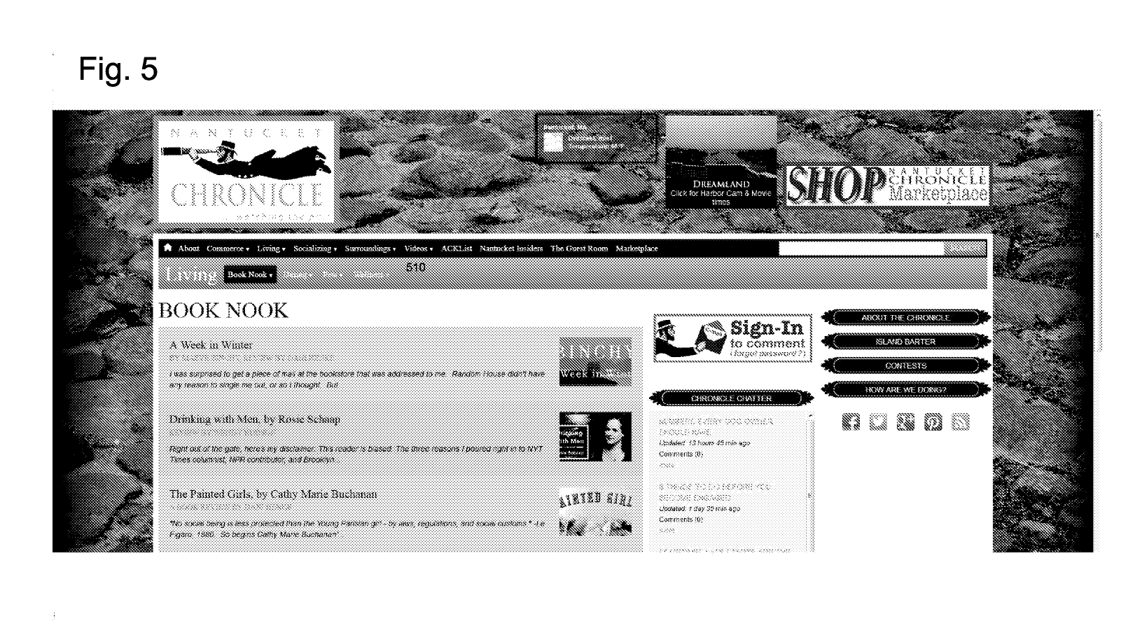

Turing to FIG. 5, shown is a screen capture of the front-end of a website showing local-based and local-generated content that is integrated with a local-based e-commerce platform. Such local-generated content 510 may include the following:
A. Living: Pets, Parenting, Dining, Wellness and Advice, Sports, School activities;
B. Socializing: Arts & Entertainment, Philanthropic Activities
C. Surroundings: Home and Garden, The Outdoor World, Sustainability
D. Commerce: Real Estate News, Business Profiles, What's In Store, Business Coaching.
E. The Guest Room: a place for contributors who are not residents.

In general, the content 510 on the website may include one or more of the following:
A. Original essays on topics including real estate, gardening, parenting, dining out, sustainability, the great outdoors, art and antiques, history and preservation, health and wellness and local commerce, including business coaching and profiles of local business people.
B. Photographs of local individuals, pets, architectural elements or businesses.
C. Blog posts from other sites deemed to be of interest to local residents
D. Book reviews, with links to local booksellers to keep purchases within the community.
E. Restaurant reviews and news of openings, closings, menus and events.
F. Videos by local videographers, both professional and amateur.
G. Local TV channel content.
H. A community calendar that any registered user may use to place any upcoming event.
I. A barter column
J. An advice column
K. A classified ads section.
L. A section particularly intended for civil discussion of local and non-local public issues in a moderated forum.

Contributors of the foregoing content may already be active online, whether through their own blogs or through Facebook or other social media. Participation may be encouraged throughout the website by emphasizing the notion of sharing what they are already passionate about, and the communal nature of the enterprise.

All posts on all topics may be able to accept comments by registered users. Contributors may be notified when a comment is placed on their post so as to be able to reply to the comment and to moderate the discussion to eliminate malicious or other objectionable comment.

Eligibility for website users to become a registered users may be limited to users who have a residence within the community (whether part-time or full-time). Or there may be different classes of registered users that have different access rights to the website depending on their status within the local community (full-time resident, part-time resident, visitor, non-visitor).

In general, the content for this website will be generated from within the local community, not from outside the community. This goal may be realized by the use of website administrators who are from the community and deeply aware of its traditions, values, conflicts and relationships. There may be multiple tiers of such website administrators (such as founders, managers and assistants) with varying responsibilities to develop, promote and maintain localized content on the website. Lower-tiered website administrators may be responsible for maintaining areas of the website of particular concern to them or where they have superior local knowledge. Upper-tier website administrators may be responsible for the overall “look and feel” of the website and to ensure that the website maintains is local flavor in a pleasing and consistent manner. Website administrators may be compensated from commissions generated by the website or may serve without compensation.

The website administrators may also identify potential contributors in each of the areas covered such as local artisans, retailers and artists to participate in the e-commerce section of the website. Minimal marketplace participation charges may be set to encourage wide use among local artists, artisans and retailers. Revenue may be earned as a percentage of sales, and participating merchants may be attracted to using the website to capture sales from new sources.

The one or more website administrators may also be responsible to accomplish one or more of the following tasks:
A. organize the website so that it is easy for contributors to post content, add links and promote their own and others' posts on all social media;
B. make the e-commerce component robust and easily reached on the home page;
C. use search engine optimization techniques to drive traffic to the website;
D. ensure that the website is visually appealing, well-organized and user-friendly;
E. enable advertising in flexible sizes, shapes and positions while not detracting from the substantive nature of the site;
F. ensure that the website is primarily administered by the contributors themselves with minimal ongoing need for a web manager;
G. ensure that the website is straightforward for participating merchants to create their online storefronts and upload information regarding their products;
H. ensure that the website is straightforward for purchasers to buy, confirm and receive tracking information for their purchases;
I. ensure that the website is secure for credit card purchases;
J. ensure that the website offers each merchant its own page to profile its studio or shop;
L. ensure that the website offers each merchant product pages, each with a description and photographs of the product offered;
M. ensure that the website is efficient in notifying merchants, purchasers and administrators when a sale takes place, when an item is shipped and when a payment is required to the merchant; and
N. ensure that the website provides proper and useful reporting of marketplace transactions.

Accordingly, a robust website as described may include both commercial and non-commercial content that is locally generated and locally controlled. The website may promote “buy local” economic activity by providing an e-commerce platform for local artists, retailers and artisans to sell year-round even if such merchants are normally limited to a “season” of several months (as is common in resort communities). The website may distribute a certain pre-determined percentage of its revenue back out to its contributors. This may be appealing to local contributors and advertisers since it means that ad revenue is returned to the local community. The website may also include a variety of cross-promotions with local businesses that enhances the visibility of the site among local residents. The website may include promotion of local events to increase community participation in all aspects of community life, whether commercial, humanitarian or philanthropic.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A website comprising:
a control portal associated with a locality and a website administrator;
a content portal, the content portal comprising at least one content data set associated with the locality;
a commerce portal, the commerce portal comprising:
at least one commerce data set associated with the locality and at least one merchant data set;
wherein the at least one merchant data set comprises merchant data, price data, commission data and goods data;
wherein the commission data comprises a revenue split related to the merchant data and the website administrator.

2. A website as in claim 1, wherein the commerce portal and the content portal are both accessible from the homepage of the website.

3. A website as in claim 2, wherein the website incorporates search-engine optimization techniques.

4. A website as in claim 2, wherein the website utilizes social media promotion techniques.

5. A website as in claim 2, wherein the content portal further comprises at least one contributor that provides locality information to at least one content data set.

6. A website as in claim 5, wherein the website administrator shares revenue produced by the website with at least one contributor.

7. A website as in claim 5, wherein the locality information includes at least one member selected from of a group consisting of: locality-based living information, locality-based socializing information and locality-based surrounding information.

8. A system comprising:
a general-purpose computer running a website, wherein the website comprises:
a control portal associated with a locality and a website administrator;
a content portal, the content portal comprising at least one content data set associated with the locality;
a commerce portal, the commerce portal comprising:
at least one commerce data set associated with the locality and at least one merchant data set;
wherein each of the at least one merchant data set further comprises merchant data, price data, commission data and goods data;
wherein the commission data comprises a revenue split related to the merchant data and the website administrator;
at least one user accessing the content portal and the commerce portal; and
at least one website administrator accessing the control portal.

9. A system as in claim 8, wherein the commerce portal and the content portal are both accessible from the homepage of the website.

10. A system as in claim 9, wherein the website incorporates search-engine optimization techniques.

11. A system as in claim 9, wherein the website utilizes social media promotion techniques.

12. A system as in claim 9, wherein the content portal further comprises at least one contributor that provides locality information to the at least one content data set.

13. A system as in claim 12, wherein the website administrator shares revenue produced by the website with at least one contributor.

14. A system as in claim 12, wherein the locality information includes at least one member selected from of a group consisting of locality-based living information, locality-based socializing information and locality-based surrounding information.

15. A method comprising:
administering a control portal associated with a locality and a website administrator;
administering a content portal, the content portal comprising at least one content data set associated with the locality;
administering a commerce portal, the commerce portal comprising:
at least one commerce data set associated with the locality and at least one merchant data set;
wherein each of the at least one merchant data set comprises merchant data, price data, commission data and goods data;
wherein the commission data comprises a revenue split related to the merchant data and the website administrator.

16. A method as in claim 15, wherein the commerce portal and the content portal are both accessible from the homepage of the website.

17. A method as in claim 16, wherein the website incorporates search-engine optimization techniques.

18. A method as in claim 16, wherein the website utilizes social media promotion techniques.

19. A method as in claim 16, wherein the content portal further comprises at least one contributor that provides locality information to the at least one content data set.

20. A method as in claim 19, wherein the website administrator shares revenue produced by the website with at least one contributor.
